(19) United States
(12) Patent Application Publication
(10) Pub. No.: US 2020/0346163 A1
(43) Pub. Date: Nov. 5, 2020

(54) COST-EFFECTIVE GAS PURIFICATION METHODS AND SYSTEMS BY MEANS OF EJECTORS

(71) Applicant: Her Majesty the Queen in Right of Canada as Represented by the Minister of Natural Resources, Ottawa (CA)

(72) Inventors: Marzouk BENALI, Mont-Saint-Hilaire (CA); Hamed BASHIRI, Montreal (CA); Zine AIDOUN, Laval (CA); Khaled AMEUR, Montreal (CA); Hristo SAPOUNDJIEV, Greenfield Park (CA)

(21) Appl. No.: 16/958,139

(22) PCT Filed: Jan. 24, 2019
(86) PCT No.: PCT/CA2019/050085

§ 371 Date: Jun. 25, 2020

Related U.S. Application Data
(60) Provisional application No. 62/621,266, filed on Jan. 24, 2018.

(51) Int. Cl. B01D 53/14; B01D 53/18; B01D 53/52; B01D 53/78

(52) U.S. Cl. CPC B01D 53/1462; B01D 53/18; B01D 53/526; B01D 2252/204; B01D 53/78; B01D 2252/2021; B01D 53/1425

(57) ABSTRACT

The invention provides methods and systems for reducing cost and energy consumption of gas purification processes that use physical or chemical absorbents. These methods and system provide a novel approach to vaporize process energy wastes including thermodynamic inefficiencies and waste heat by optimally integrating ejector technology into gas purification processes. These methods and systems use single-phase and/or two-phase ejectors as alternatives to mechanical compressors or pumps for recirculating fluid between vessels or as part of the cooling system associated to the gas purification processes.

### FIELD OF THE INVENTION

The present invention relates to gas purification processes for removing acidic components comprising CO₂ or H₂S or SO₂ or COS or a combination of at least two of these components by means of liquid absorbents.

### BACKGROUND OF THE INVENTION

The present invention relates to gas purification processes for removing acidic components comprising CO₂ or H₂S or SO₂ or COS or a combination of at least two of these components by means of liquid absorbents. Examples of the gases that contain these acidic components are gasification gases, synthetic gases, coke oven gases, combustion gases and natural gases.

Gas purification process is a key step as the acidic gases in the synthesis gas (syngas) or in the industrial off-gases are often not environmentally friendly and they can also poison downstream catalysts often used for production of liquid fuels or added-value products and can also promote corrosion of turbines used for electricity production. For example, the limits for sulphur compound species are 50 ppb (parts-per-billion, 10⁻⁹) for catalysts used a Fischer-Tropsch (FT) synthesis process and 50 ppm (parts-per-million, 10⁻⁶) for gas turbines.

It has been disclosed in existing prior art that acidic gases and impurities in a gas stream can be removed by either physical or chemical absorbents in absorption or absorbent columns. As used herein, the term column wherein liquid and vapour phase are co- or counter-currently contacted to separate fluid mixture, as for example, by contacting of the vapour and liquid phases on a series of vertically spaced trays or plates mounted within the column and or on packing elements such as a structured or random packing. Afterwards, the absorbent can be regenerated in vessels comprising flash, stripping and/or regeneration columns.

Overall, capital and operating expenditure associated with gas purification processes are significantly high, in the order of millions of dollars.

There are, inter alia, three main reasons that make these processes energy intensive:
(1) mechanical compressors and pumps are typically used in these processes for compression purposes that use electricity as high quality source of energy;
(2) enormous amount of high quality steam is often used in reboiler of absorbent regenerating column to satisfy duty of reboiler; and
(3) energy-intensive cooling is required to maintain the effectiveness of these gas purification processes since absorption is an exothermic phenomenon.

Recently, mechanical vapour recompression (MVR) or conventional heat pumps has been used to improve the efficiency of these systems.

The current approach has numerous disadvantages. For example, MVR systems use high quality energy (electricity) to run compressors. Moreover, these technologies are subject to operational malfunction and costly repairs, among other factors, by using multiple moving parts. Although absorption, adsorption and chemical heat pump technologies can use waste energy recovery, these technologies are complex, costly and cumbersome to operate with modest performance and thus far have been found to be unreliable.

However, there are several factors in making gas purification processes and systems cost-effective, which cannot be well reflected in a common optimization problem, e.g. understanding the operational bottlenecks, defining the actual energy distribution within the processes or systems, having advanced knowledge in thermal energy recovery processes, etc.

In this context, ejectors with diverse designs have been used in the past in place of mechanical compressors in industrial processes, such as gas purification, mainly for creating vacuum environment and also air conditioning and refrigeration systems.

Ejectors operate based on the principle of interaction between two fluid streams at different energy levels. The primary or motive stream that can be gas or liquid has higher total energy level while the secondary or driven stream has lower total energy. The mechanical energy transfer from the primary stream to the secondary stream imposes a compression effect on the secondary stream.

Even though the overall efficiency of ejectors is generally lower than alternative technologies such as mechanical compressors, ejectors have the great advantages such as simplicity in their design and construction with no moving parts, as well as low manufacture and maintenance costs. Their main advantage is the ability to recover waste heat or thermodynamic inefficiency of the process as motive energy to operate while saving high quality energy.

Therefore, there remains the need for methods of energy and capital expenditure management of gas purification system using optimal integration of ejector technology in these processes.

### SUMMARY OF THE INVENTION

According to one aspect of the invention, the invention discloses the use of high-pressure gas streams existing in gas purification processes as a motive flow in one or multiple single-phase ejector(s), thus eliminating or reducing the high capital and operating costs of mechanical compressor used in prior art. Feed gas to absorber, clean syngas or high purity CO₂ stream is used as a high-pressure stream to activate said ejector. The stream is used in a way that it does not violate design specifications of downstream equipment. The single-phase ejector compresses the gases to be sent back to the upstream high-pressure vessels such as absorption or absorbent column(s) of physical absorbent or to decrease the compression work of downstream compressors or pumps.

According to another aspect of the invention, the invention discloses the use of high-pressure liquid stream in gas purification process as a motive flow in one or multiple liquid-gas ejector(s) eliminating or reducing the high cost encountered mechanical compressor in MVR system used in prior art. Loaded or partially loaded absorbent is used to compress the gas to produce a gas-liquid mixture with increased pressure. This mixture is then sent to desorption column (e.g. stripper) in a way that it does not violate design specifications of downstream equipment.

According to a further aspect of the invention, the invention discloses the use of higher-pressure liquid stream in gas purification process as a motive flow in one or multiple liquid-gas ejectors eliminating or reducing the duty of the high cost encountered with a reboiler used in prior art. Loaded or partially loaded absorbent is used to compress the gas to produce a gas-liquid mixture with increased pressure. This mixture is then sent to desorption column (e.g. stripper) in a way that it does not violate design specifications of downstream equipment.

According to a further aspect of the invention, the invention discloses at least two (2) ejectors activated by any type of waste heat in order to eliminate or reduce the duty of a reboiler. The number of ejectors is varied depending on the conditions and needs in the gas purification process. For example, the absorption is an exothermic process and the generated heat has to be removed by intercooler in absorption column. This heat is then used to activate the single-phase ejector; and the liquid that is fully and partial drawn from the reboiler is then flashed, vapourized and recompress back to the stripper column.

According to one aspect of the invention, there is provided a use of an ejector in a gas purification system, wherein high-pressure gas or liquid stream in the gas purification system is used as a motive flow in the ejector, wherein the ejector then compresses the gas stream to be sent back to upstream high-pressure vessels.

According to another aspect of the invention, there is provided a gas purification system, wherein: a feed of raw gas comprising acidic gases is treated in an absorber column by a lean absorbent entering into the absorbent column and in contact with said acidic gases, said lean absorbent absorbs acidic gases to provide a laden absorbent, said laden absorbent with acid gases is then depressurized by a valve to separate volatile fuel species that are co-absorbed with acid gases in a separator to provide a loaded absorbent, the loaded absorbent is returned into the absorbent column by being injected into the feed gas using an ejector.

According to a further aspect of the invention, there is provided gas purification system, wherein: a feed of raw gas comprising acidic gases is treated in an absorber column by a lean absorbent entering into the absorbent column and in contact with said acidic gases, said lean absorbent absorbs acidic gases to provide a laden absorbent, said laden absorbent with acid gases is then depressurized by a first valve to separate volatile fuel species that are co-absorbed with acid gases in a separator to provide a loaded absorbent, the loaded absorbent is depressurized using a second valve and fed to absorbent regeneration unit using an ejector.

### BRIEF DESCRIPTION OF THE DRAWINGS

By way of example only, preferred embodiments of the present invention are described hereinafter with reference to the accompanying drawings, wherein:

FIG. 1 is an overview of the gas purification process (prior art);

FIG. 2 is a scheme of a sectional partial view of an ejector (prior art);

FIG. 3 is a scheme of the absorption section of gas purification process: one-section absorption (prior art);

FIG. 4 is a scheme of the absorption section of gas purification process: two-section absorption (prior art);

FIG. 5 is a process flow scheme according to the present invention wherein ejectors are used in place of high-cost mechanical vapour compressors to recycle back fuel species into the absorber column;

FIG. 6 is a scheme of the desorption section of a gas purification process (prior art);

FIG. 7 is a scheme of an alternative desorption section of a gas purification process (prior art);

FIG. 8 is a scheme of the desorption section of a gas purification process in which a MVR system is used to reduce the cost of reboiler (prior art);

FIG. 9 is a process flow scheme according to the present invention for the desorption section of a gas purification process wherein an ejector is used in place of high-cost mechanical vapour compressor in MVR system to reduce the cost of reboiler;

FIG. 10 is a process flow scheme of according to the present invention for the desorption section of a gas purification process wherein an ejector is used to eliminate the use of a reboiler;

FIG. 11 is a scheme of typical gas purification process using chemical absorbent and with integrated MVR system (prior art); and

FIG. 12 is a process flow scheme according to the present invention wherein an ejector is used to reduce the cost of reboiler by utilizing waste heat.

### DETAILED DESCRIPTION OF THE INVENTION

The present invention will now be described with reference to the accompanying drawings, in which some, but not all embodiments of the invention are shown.

### LIST OF REFERENCE CHARACTERS

1 Raw gas/syngas/feed gas
2 Absorber column(s)
3 Purified gas
4 Laden absorbent
5 Lean absorbent
6 Cooling apparatus
7 Heating apparatus
8 Absorbent regeneration unit(s)
9 Acid gases
10 Inlet end of an ejector
11 Suction nozzle in an ejector
12 Converging nozzle in an ejector
13 Diverging nozzle in an ejector
14 Secondary nozzle section in an ejector
15 Constant cross-section in an ejector
16 Diffuser in an ejector
17 Pressure increase
18 Gas compressor
19 Gas cooler
20 Valve to depressurize
21 Separator
22 Mechanical compressor
23 Volatile fuel species
24 Loaded absorbent
25 Gas-gas ejector
26 Reboiler
27 Condenser
28 Expansion valve
29 Heat exchanger
30 Liquid-gas ejector
31 Intercooler
32 Lean-rich exchanger
33 Intercooler heat exchanger

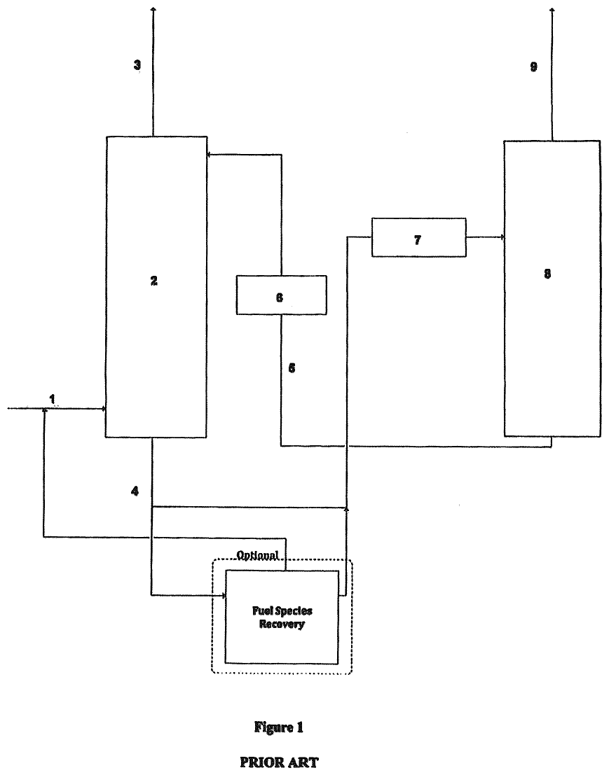

FIG. 1 is an overview of the gas purification process. Raw gas 1 comprising acidic gases which further comprises 1 to 90 mole % of CO₂, 1 mole ppm to 50 mole % of H₂S, and other types of impurities (e.g. COS, SOₓ, etc.) is treated in absorber column(s) 2, wherein said acidic gases are in contact with lean absorbents 5, said lean absorbents may comprise physical (e.g. Rectisol®, Selexol™, Purisol™), chemical absorbents (e.g. MEA, MDEA, DEA, hot potassium carbonate, sodium carbonate, Shell Cansolv™, etc.), or both (e.g. Shell Sulfinol™), and/or other chemicals.

These lean absorbents 5 are used to: (1) promote the rate of absorption; (2) prevent chemical solvent degradation (inhibitor); (3) prevent corrosion. The optimal choice of the lean absorbents depends on the feed gas compositions, pressure and characteristic and concentration of the acidic components.

Said lean absorbents 5 often are chilled using a chiller or cooling apparatus 6, for example, a heat exchanger, before being sent to the absorber column(s) 2. The acidic components are absorbed in the solvent in the absorber column(s) 2. The acidic gases can be treated in a single or several absorbent column(s) 2. Absorbent column(s) 2 can have pressure and temperature in the range of 1-110 bars and −60 to 110° C. respectively, depending on the absorbent used. Purified gas 3 is then taken from the top of absorbent column(s) 2 and above the section where the fresh absorbent is introduced to said absorbent column(s). Laden absorbent 4 with acid gases are then taken off at the bottom of absorption zone(s).

It has been disclosed in prior art that the laden absorbent 4 can then be optionally sent to a set of flash drums which have a lower pressure than absorber column(s) in order to vapourize and recycle back some volatile fuel species that have been co-absorbed with acid gases comprising CO or H₂ to the column inlet. The operating pressures of these vessels are kept in the range in which the acid gases are remained in the laden solvent. A set of mechanical compressors are used to boost the pressure of these fuel species in order to send them into the absorbent column(s) that operates at higher pressure. This was generally used for physical solvents such as dimethylether of polyethylene glycol (DMPEG), methanol, a mixture of N-formyl and N-acetyl morphine, N-methyl-2-pyrrolidone and sulfolane.

Laden absorbent 4 often needs to be heated up by one or several heating apparatus 7, for example, a heat exchanger, and then sent to a set of absorbent regeneration unit(s) 8 such as flash drum(s) or stripper(s) depending on the employed absorbent where acidic components are removed selectively or simultaneously as acid gases 9 in several absorbent recovery steps. Afterwards, the resulting lean absorbent that has low concentration of acidic components is often needed to be cooled down using one or several cooling apparatus 6, for example, a heat exchanger, and then returned back to the absorber column(s) 2.

It has been further disclosed in the prior art that stripper columns equipped with reboilers (not shown) may be used to separate acid gases 9 from the solvent. In some prior art, especially when physical solvents were used as absorbents, an inert gas (e.g. nitrogen) was used to strip acid gases 9 and produce lean absorbents or solvent and consequently energy intensive steps such as steam stripping and heating of acid gas loaded solvent was reduced or eliminated.

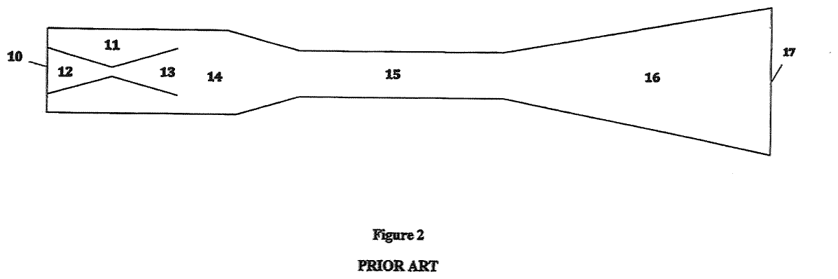

FIG. 2 shows a sectional partial view of an ejector. Motive fluid is delivered to the ejector at inlet end 10 that is expanded through either converging nozzle 12 and diverging nozzle 13 or only converging nozzle 12 to high velocity and low pressure stream. This high velocity and low-pressure stream entrains the suction fluid through suction nozzle 11. The motive and suction fluids are then mixed in the mixing section or chamber that comprises secondary nozzle section 14 and constant cross-section 15. Afterwards, the resulted high-speed mixed flow is decelerated in a diffuser 16 and static pressure is recovered, resulting in a pressure increase 17 provided to the suction stream across the ejector.

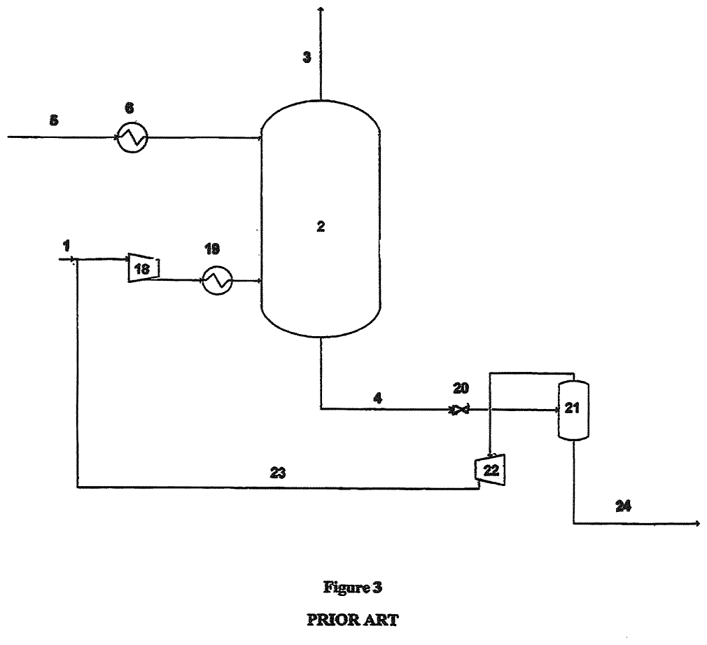

FIG. 3 shows the absorption section of gas purification process, known in the prior art, wherein lean absorbent 5 that has very low level of acid gases is chilled by cooling apparatus 6. The chilled lean absorbent then enters into absorbent column(s) 2 to contact feed of raw gas 1 (or gas from another purification unit) entering absorbent column(s) 2 after its pressure and temperature reach satisfactory levels using a gas compressor 18 and gas cooler 19, respectively. The absorber column(s) 2 may have one or multiple side coolers (not shown) to remove a fraction of the heat of absorption (i.e., heat released by the acid gases as a consequence of the phase-change) by cooling the absorbent liquid stream. Laden absorbent 4 is then depressurized using a valve 20 to separate volatile fuel species 23 that are co-absorbed with acid gases in a separator 21 and returned back into the absorbent column(s) 2 by injecting them into the feed gas using a mechanical compressor 22. The rest of loaded absorbent (e.g. loaded solvent) 24 is sent either to another absorbent unit to remove other impurities or to be regenerated. Purified gas 3 leaves the top of absorbent column(s) 2.

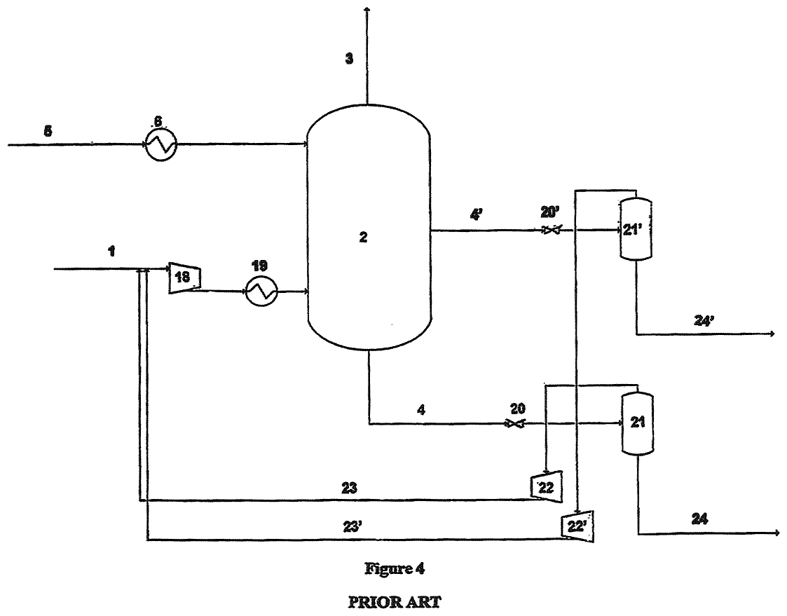

As shown in FIG. 4, when sulphur containing acid gases (e.g. H₂S, SO₂, COS, etc.) and CO₂ co-exist in raw gas 1, the absorbent column(s) 2 can be divided into two sections: at the bottom part essentially all the sulphur containing acid gases are removed, and at the upper part the remaining CO₂ is removed from the gas. This can be obtained in single or multiple columns to meet design specification. This design configuration is known to a person skilled in the art when CO₂ is going to be utilized for other processes that have stringent purity requirement (e.g. food grade CO₂, or CO₂ that needs to be used for enhanced oil recovery). Laden absorbent 4′ (with more concentration of CO₂) and laden absorbent 4 (with more concentration of H₂S) are then depressurized using valve 20′ and 20 respectively to separate volatile fuel species 23′ and 23 respectively that are co-absorbed with acid gases in separator 21′ and 21 respectively and returned back into the absorbent column(s) 2 by injecting them into the feed gas using a mechanical compressor 22′ and 22 respectively. The rest of loaded absorbents (e.g. loaded solvent) 24′ and 24 respectively are sent either to another absorbent unit to remove other impurities or to be regenerated. Purified gas 3 leaves the top of absorbent column(s) 2.

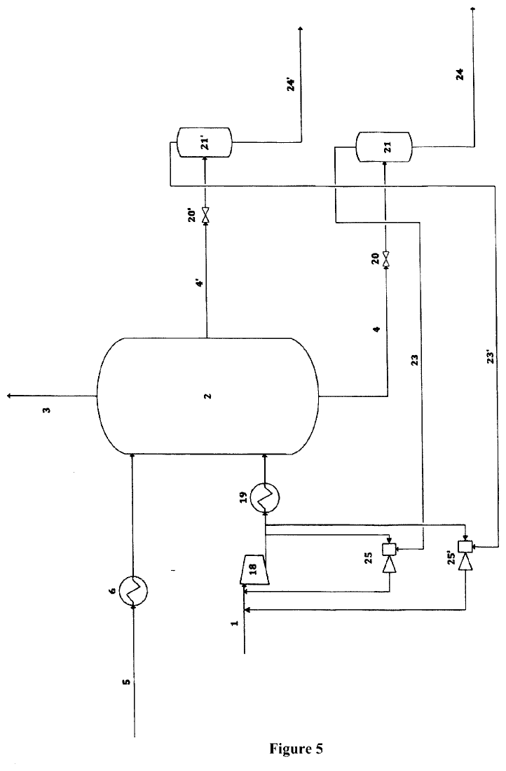

FIG. 5 is a process flow scheme according to the present invention wherein ejectors are used in place of high-cost mechanical compressors to recycle back fuel species into the absorber column.

Referring to FIG. 5, ejectors are used in the place of high cost mechanical gas compressor to return volatile fuel species to the column inlet that have been co-absorbed with acid gases. Raw gas/feed gas 1 (or the gas from other purification unit) enters advantageously into the bottom of absorber column(s) 2 after its pressure and temperature reaches satisfactory levels using a gas compressor 18 and gas cooler 19, respectively. Lean absorbent 5 that has very low level of acid gases is chilled by cooling apparatus 6 and then enters into absorbent column(s) 2 to contact raw gas 1. The absorber column(s) 2 may have one or multiple side coolers (not shown) to remove a fraction of the heat of absorption (i.e., heat released by the acid gases due to the phase-change) by cooling the absorbent liquid stream. Laden absorbent 4′ (with more concentration of CO₂) and laden absorbent 4 (with more concentration of H₂S) are depressurized using valves 20′ and 20 respectively to separate volatile fuel species in separators 21′ and 21 respectively. Loaded absorbent 24′ and 24 are returned back into the absorbent column(s) 2 by injecting them into the feed gas using the gas-gas ejectors (25′ and 25) respectively.

The system may optionally comprise a plurality of supersonic ejectors (not shown), which can be operationally located according to the intended end use and operational environment of the system, and may be located in series, in parallel, or combination thereof. These ejectors are activated by small fraction of the pressurized feed/raw gas as such the backpressures of mixtures at the outlet of ejectors are slightly above pressure of feed/raw gas. The ejectors may have the same geometry as that shown in FIG. 2. This motive flow (the pressurized feed/raw gas) is accelerated in the primary converging nozzle 12 where it reaches supersonic velocity, creating a depression at the secondary nozzle section 14, and drawing the secondary flow coming from the separators at a lower pressure. Both flows enter in contact before reaching the constant cross-section 15 of the mixing chamber, where the two velocities equalize at a constant pressure and a series of shock waves occur, accompanied by a significant pressure rise, while the velocity decreases to become sub-sonic. Afterwards, the flow enters a diffuser 16, where the flow further slows down and it allows the conversion of the remaining velocity into static pressure and the mixed flow reaches the intermediate pressure, which is slightly above the pressure of feed gas. The rest of loaded absorbents (24′ and 24) are sent either to another absorbent unit to remove other impurities or to be regenerated. Purified gas 3 leaves the top of absorbent column(s) 2.

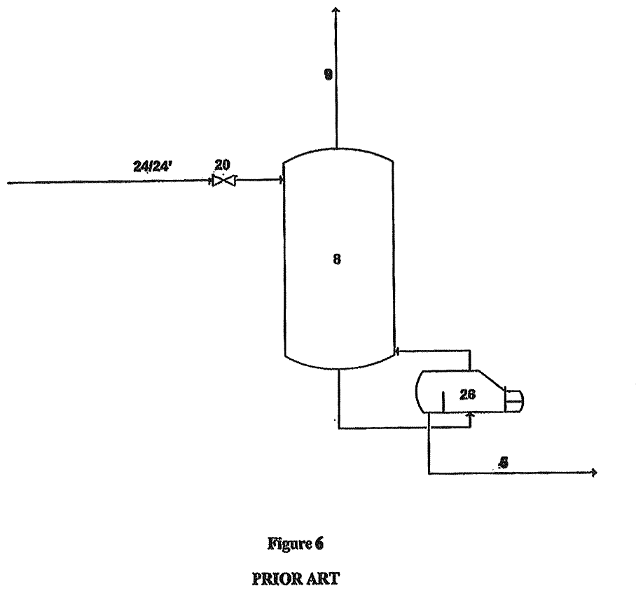

FIG. 6 shows the desorption section known in prior art wherein loaded absorbents (for example 24/24′) are depressurized using valve 20 and are fed to absorbent regeneration unit(s) 8 at the top which are flashed inside the unit(s) and release impurities in vapour state and the regenerated solvent flows down and washes the lower portion of unit. The reboiler 26 (e.g. kettle reboiler) at the bottom of the unit(s) can further remove the acid gases in the absorbent and send the lean absorbents 5 to the absorption unit or another desorption unit for further purification of absorbents.

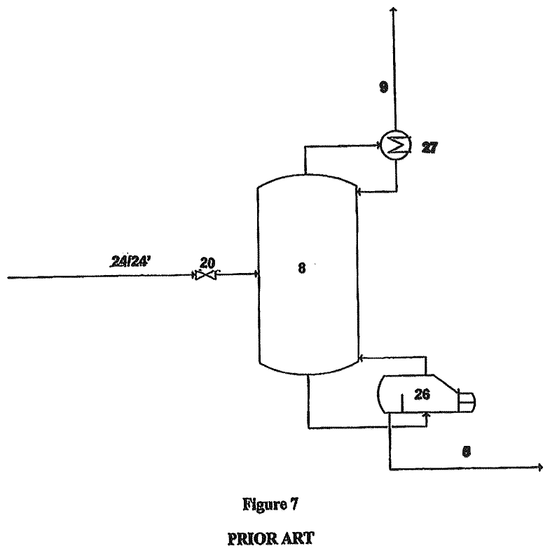

FIG. 7 shows another design desorption section disclosed in prior art wherein loaded absorbents (for example 24/24′) are depressurized using valve 20 and fed to absorbent regeneration unit(s) 8 at the middle, where impurities are released in a vapour state and the regenerated solvent flows down and washes the lower portion of the unit(s). In this configuration, a condenser 27 is used at the top of the absorbent regeneration unit(s) 8 in which all the absorbent in the vapour state is condensed and return back to the unit(s) to wash the upper portion of unit(s). The reboiler 26 (e.g. kettle reboiler) at the bottom of the unit(s) can further remove the acid gases in the absorbent and send lean absorbents 5 to the absorption unit or another desorption unit for further purification of the absorbents.

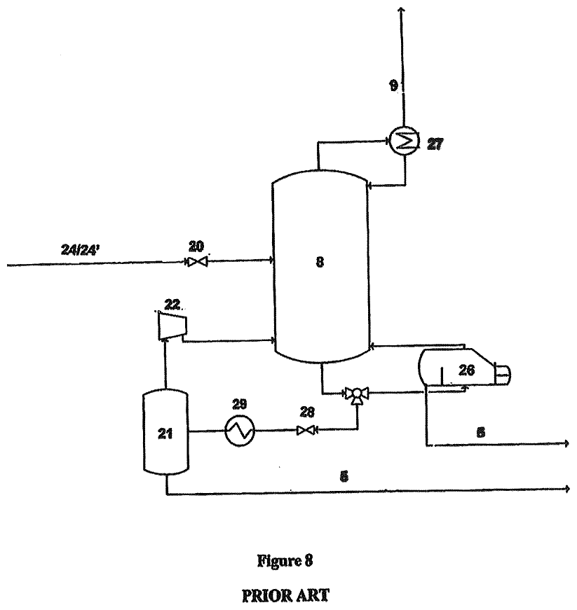

FIG. 8 shows another design modification of desorption section disclosed in prior art wherein a MVR system is used for energy management of the system shown in FIG. 7. Loaded absorbents (for example 24/24′) are depressurized using a valve 20 and fed to absorbent regeneration unit(s) 8 at the top, where impurities are released in a vapour state and the regenerated solvent flows down and washes the lower portion of the unit(s). The reboiler 26 (e.g. kettle reboiler) at the bottom of the unit(s) can further remove the acid gases in the absorbent and send lean absorbents 5 to the absorption unit or another desorption unit for further purification of the absorbents. A part of liquid that is drawn from the bottom of the unit(s) is then conducted to an expansion valve 28 and then temperature is regulated in a heat exchanger 29. A mechanical compressor 22 draws the vapour from the separator 21 and sends it to absorbent regeneration unit(s) 8. It was shown that this strategy decreases the energy consumption of reboiler 26.

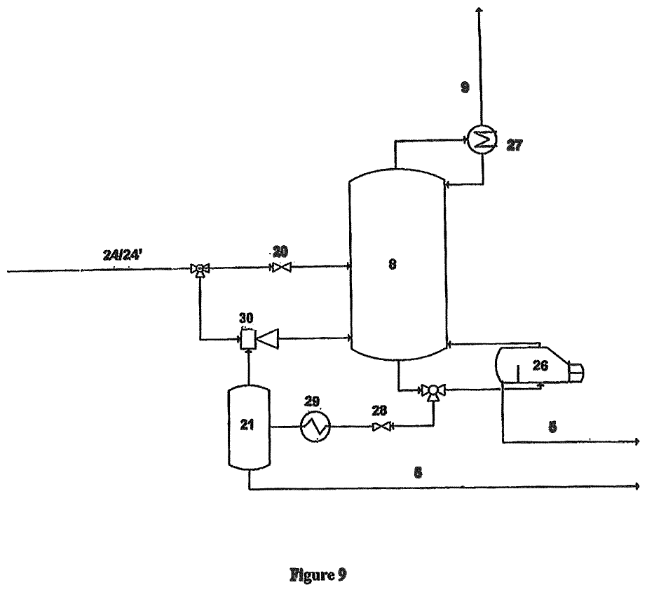

FIG. 9 is a process flow scheme of an embodiment according to the present invention of the desorption section of a gas purification process wherein an ejector is used in place of high-cost mechanical compressor in MVR system as depicted in FIG. 8 in order to reduce the cost of reboiler.

Referring to FIG. 9, ejectors are used in the place of high cost gas compressor in the MVR system. Loaded absorbents (for example 24/24′) are depressurized using a valve 20 and fed to absorbent regeneration unit(s) 8 at the top, where impurities are released in a vapour state and the regenerated solvent flows down and washes the lower portion of the unit(s). The reboiler 26 (e.g. kettle reboiler) at the bottom of the unit(s) further removes the acid gases in the absorbents and send the lean absorbents 5 to the absorption unit or another desorption unit for further purification of the absorbents. A part of liquid that is drawn from bottom of the unit(s) is conducted to an expansion valve 28 and then temperature is regulated in a heat exchanger 29. Liquid-gas ejector(s) 30 draw the vapour from separator 21 at lower pressure and send it to absorbent regeneration unit(s) 8 with relatively higher pressure. Using this strategy, the system can cool down the regenerated absorbent stream that can significantly reduce the refrigeration energy requirement (for example in cooling apparatus 6, not shown). A fraction of the loaded liquid absorbent coming from an absorption unit or other desorption units that has relatively higher pressure compared to absorbent regeneration unit(s) 8 can be used to activate the liquid-gas ejector(s) 30.

The liquid-gas ejectors 30 may have the same geometry as that is shown in FIG. 2. The operation mechanisms of liquid-gas ejectors are similar in principle to that of gas-gas ejectors 25 except that the primary fluid (high pressure) is liquid and the secondary fluid (low pressure) is vapour. The motive fluid (high pressure liquid) enters into the nozzles 12 and/or 13 at a relatively high pressure. Reduction of the pressure of the liquid in the nozzles 12 and/or 13 provides the potential energy for conversion to kinetic energy of the liquid. The driving flow entrains vapour out of the separator 21. The liquid and vapour phases mix in the mixing chamber comprising of secondary nozzle section 14 and constant cross-section 15 and leave the latter after a recovery of pressure in diffuser 16. As a result, a two-phase mixture of intermediate pressure is obtained that can be injected to absorbent regeneration unit(s) 8.

The system may optionally comprise a plurality of liquid-gas ejectors, which can be operationally located according to the intended end use and operational environment of the system, and can be located in series, in parallel, or combination thereof. These ejectors are activated by the pressurized liquid as such the back-pressures of mixtures at the outlet of ejectors are slightly above pressure of regeneration column. This strategy of integration of ejector(s) into the desorption section of gas purification process substantially reduces the energy consumption of reboiler 26.

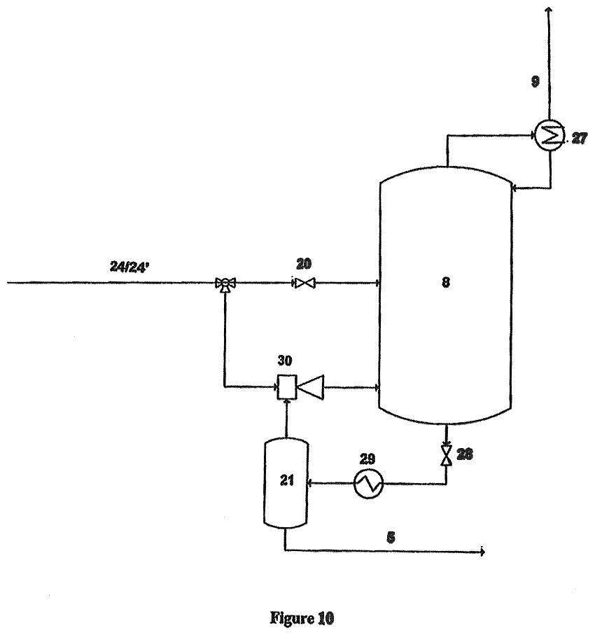

FIG. 10 is a process flow scheme of another embodiment according to the present invention for desorption section of a gas purification process wherein an ejector is used to eliminate the reboiler.

Referring to FIG. 10, loaded absorbents (for example 24/24′) are depressurized using a valve 20 and fed to absorbent regeneration unit(s) 8 at the top which is flashed inside the unit(s) and release the impurities in vapour state and the regenerated solvent flows down and washes the lower portion of the unit(s). The liquid that is drawn from the bottom of the unit(s) is conducted to an expansion valve 28 and then temperature is regulated in a heat exchanger 29. Liquid-gas ejector(s) 30 draw the vapour from the separator 21 at lower pressure and send it to absorbent regeneration unit(s) 8 with relatively higher pressure. Using this strategy the system can cool down the regenerated absorbent stream that can significantly reduce the refrigeration energy requirement (for example in cooling apparatus 6, not shown). A fraction of loaded liquid absorbent coming from an absorption unit or other desorption units that has relatively higher pressure compared to absorbent regeneration unit(s) 8 can be used to activate the liquid-gas ejector(s).

The liquid-gas ejectors 30 may have the same geometry as that is shown in FIG. 2. The operation mechanisms of liquid-gas ejectors are similar in principle to that of gas-gas ejectors 25 except that the primary fluid (high pressure) is liquid and the secondary fluid (low pressure) is vapour. The motive fluid (high pressure liquid) enters into the nozzles 12 and/or 13 at a relatively high pressure. Reduction of the pressure of the liquid in the nozzles 12 and/or 13 provides the potential energy for conversion to kinetic energy of the liquid. The driving flow entrains vapour out of the separator 21. The liquid and vapour phases mix in the mixing chamber comprising of secondary nozzle section 14 and constant cross-section 15 and leave the latter after a recovery of pressure in diffuser 16. As a result, a two-phase mixture of intermediate pressure is obtained that can be injected to absorbent regeneration unit(s) 8.

The system may optionally comprise a plurality of liquid-gas ejectors, which can be operationally located according to the intended end use and operational environment of the system, and can be located in series, in parallel, or combination thereof. These ejectors are activated by small fraction of the pressurized liquid as such the back-pressures of mixtures at the outlet of ejectors are slightly above pressure of regeneration column. This strategy of integration of ejector(s) into the desorption section of gas purification process can eliminate the energy consumption of reboiler in the prior art.

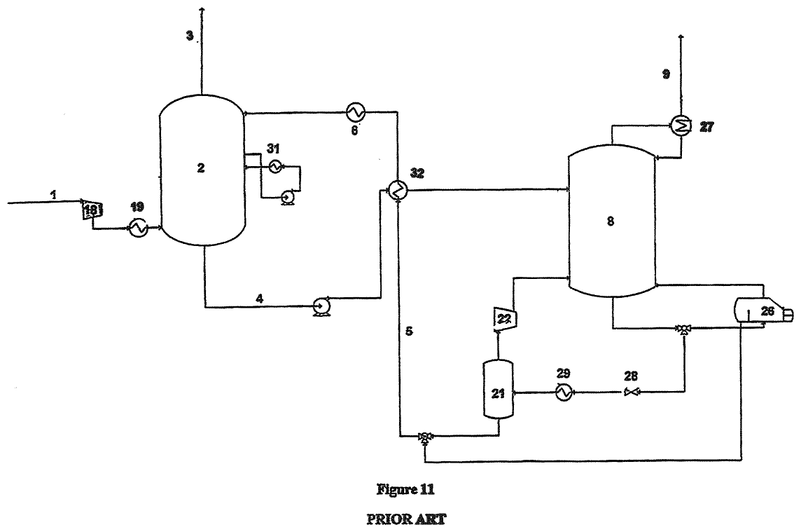

FIG. 11 shows a typical gas purification process using chemical absorbent as disclosed in prior art. Feed gas/raw gas 1 is routed to a booster fan or a gas compressor 18 to provide enough pressure to drive it through downstream equipment and out to the absorber stack and a gas cooler 19 (for example, a heat exchanger) to bring the temperature of the feed gas/raw gas to a satisfactory level. Acid gases absorption from the feed gas/raw gas 1 occurs by counter-current contact with a lean absorbent(s) 5 (physical or chemical), and lean absorbent(s) 5 are chilled using a cooling apparatus 6. The chilled lean absorbent is then fed on the top of the absorber column(s) 2 and feed gas/raw gas enters at the bottom of the absorber column 2. Acid gases are absorbed from the feed gas/raw gas to the absorbent and the laden absorbent(s) 4 come out from bottom of the absorber column(s) 2, whereas, purified gas 3 comes out from the top of absorber column(s) 2. Chemical absorption is an exothermic reaction. To prevent heat accumulation in the absorber column 2, and to improve the absorbent absorption capacity, hot absorbent is collected and pumped to the intercooler 31 and is returned back to the absorber column(s) 2 to resume acid gas absorption in the bottom section of the absorber column(s) 2. The purified gas 3 leaving the top of the absorber column(s) 2 then passes through a wash section (not shown) in order to capture any volatile and entrained absorbent mist from the purified gas. The laden absorbent 4 from the bottom of the absorber column(s) 2 is heated in a lean-rich exchanger 32 and sent to absorbent regeneration unit(s) 8, where absorbent is regenerated by the heat provided by a reboiler 26 and by a Mechanical Vapour Compressor (MVR). The reboiler 26 (e.g. kettle reboiler) at the bottom of absorbent regeneration unit(s) 8 removes the acid gases in the absorbent and send the lean absorbent 5 to the absorption unit. A part of liquid that is drawn from bottom of absorbent regeneration unit(s) 8 is conducted to an expansion valve 28 and then temperature is regulated in a heat exchanger 29. A mechanical compressor 22 draws the vapour from the separator 21 and sends it to the absorbent regeneration unit(s) 8. This contributes to the stripping of the acid gases and to the minimizing the steam requirement. The regenerated lean absorbent 5 from bottom of separator 21 of the MVR system is sent back to the absorber column(s) 2. Overhead vapour from absorbent regeneration unit(s) 8 is cooled by a condenser 27 and the two-phase mixture is separated and the reflux is returned back to the regenerator whereas, vapour (acid gases) is sent to other process units (e.g. CO₂ compression system, Claus unit).

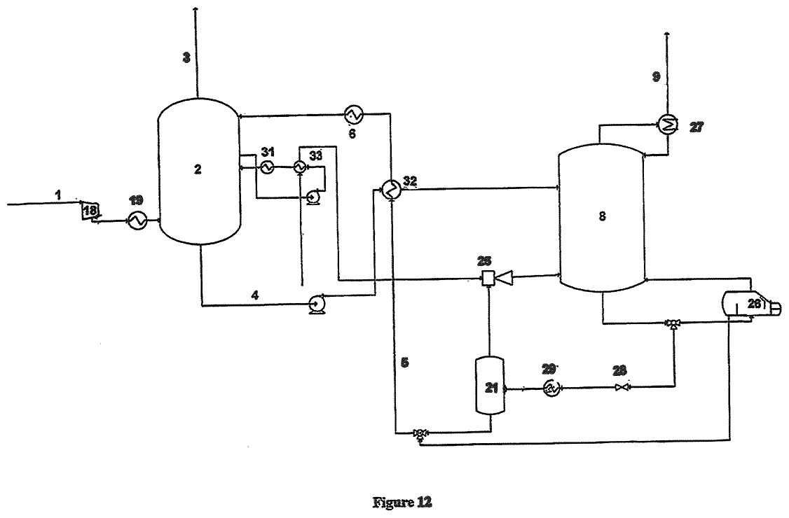

FIG. 12 is a process flow scheme of one embodiment according to the present invention wherein an ejector is used to reduce the cost of reboiler by utilizing waste heat.

Referring to FIG. 12, ejectors are used in the place of high cost mechanical gas compressor in the MVR system as shown in FIG. 11. Feed gas/raw gas 1 is routed to a booster fan or a compressor 18 to provide enough pressure to drive it through downstream equipment and out to the absorber stack and a gas cooler 19 (for example, a heat exchanger) to bring the temperature of the feed gas/raw gas to a satisfactory level. Acid gases absorption from the feed gas/raw gas occurs by counter-current contact with a lean absorbent(s) 5 (physical or chemical), and lean absorbent(s) 5 are chilled using a cooling apparatus 6. The chilled lean absorbent is then fed on the top and feed gas/raw gas enters at the bottom of the absorber column(s) 2. Acid gases are absorbed from the feed gas/raw gas to the absorbent and the laden absorbent(s) 4 come out from bottom of the absorber column(s) 2, whereas, purified gas 3 comes out from the top of the absorber column(s) 2. Chemical absorption is an exothermic reaction. To prevent heat accumulation in the absorber column(s) 2, and to improve the absorbent absorption capacity, hot absorbent is collected and pumped to the intercooler 31 and is returned back to the absorber column(s) 2 to resume acid gas absorption in the bottom section of the absorber column(s) 2. The purified gas 3 leaving the top of the absorber column(s) 2 then passes through a wash section (not shown) in order to capture any volatile and entrained absorbent mist from the purified gas. The laden absorbent 4 from bottom of the absorber column(s) 2 is heated in a lean-rich exchanger 32 and sent to absorbent regeneration unit(s) 8, where absorbent is regenerated by the heat provided by a reboiler 26 and by this invention. The reboiler 26 (e.g. kettle reboiler) at the bottom of column removes the acid gases in the absorbent and send the lean absorbent 5 to the absorption unit. A part of liquid that is drawn from bottom of absorbent regeneration unit(s) 8 is conducted to an expansion valve 28 and then temperature is regulated in a heat exchanger 29.

Single-phase gas-gas ejector(s) 25 draw the vapour from the separator 21 and send it to the absorbent regeneration unit(s) 8.

The system may optionally comprise a plurality of supersonic ejectors, which can be operationally located according to the intended end use and operational environment of the system, and can be located in series, in parallel, or combination thereof. To prevent heat accumulation in the absorber column(s) 2, and to improve the absorbent absorption capacity, hot absorbent is collected and pumped to intercooler heat exchanger 33 and intercooler 31 and is returned back to the absorber column(s) 2 to resume acid gas absorption in the bottom section of the absorber column(s) 2 so that the waste heat generated in absorbent column(s) 2 can be used to produce a vapour form of compatible fluid (e.g. water) with sufficient pressure in order to activate these ejectors as such the back-pressures of mixtures at the outlet of ejectors are slightly above pressure of absorbent regeneration unit(s) 8.

The ejectors may have the same geometry as that shown in FIG. 2. This motive flow (the pressurized feed/raw gas) is accelerated in the converging/diverging nozzles where it reaches supersonic velocity, creating a depression at the nozzle outlet, and drawing the secondary flow coming from the separator at a lower pressure. Both flows enter in contact before reaching the constant cross-section of the mixing chamber comprising of secondary nozzle section and constant cross-section, where the two velocities equalize at a constant pressure and a series of shock waves occur, accompanied by a significant pressure rise, while the velocity decreases to become sub-sonic. Afterwards, the flow enters the diffuser, where the flow further slows down and it allows the conversion of the remaining velocity into static pressure and the mixed flow reaches the intermediate pressure, which is slightly above the pressure of the absorbent regeneration unit(s). This contributes to the stripping of the acid gases and to the minimizing the steam requirement. Moreover, using this strategy can cool down the regenerated absorbent stream that can significantly reduce the refrigeration energy requirement (for example in the cooling apparatus). The regenerated lean absorbent from stripper bottom and separator of this invention is sent back to the absorber column (s). Overhead vapour from absorbent regeneration unit(s) is cooled by a condenser and the two-phase mixture is separated and the reflux is returned back to the regenerator whereas, vapour (acid gases) is sent to other process units (e.g. CO₂ compression system, Claus unit).

Referring now to FIGS. 5, 8 and 9, 10 and 12, these figures illustrate schematically the use of a single ejector. However, as mentioned above, in each of the embodiments of the invention, the single ejector shown in these figures can be replaced advantageously in many situations by a plurality of ejectors, installed in series or in parallel, or some in series and others in parallel. Their configurations and internal geometries of ejectors are variously selected so as to maximize the combinations of characteristics available to the particular system.

### EXAMPLES

### Example 1

A schematic of commonly used design configuration for absorption section of Rectisol® gas cleaning unit is shown in FIG. 4.

The syngas or raw gas 1 originates from gasifier has typically a pressure between 10-50 bar. The pressure of this stream needs to be increased by a gas compressor 18 up to 60-80 bars in order to be sent into the absorber column(s) 2 of Rectisol® wash unit.

As it is shown in the FIG. 4, the fuel species that are co-absorbed in the absorbent can be recovered by depressurizing the laden absorbent (4′ and 4) employing depressurizing valves (20′ and 20). The gas is separated in flash drums from the laden absorbent. Therefore, for recycling these fuel species that are now in the gas phase back to the feed of absorbent column(s), a set of compressors (22′ and 22) should be used. Depending on the capacity of gas cleaning unit these compressors can have very high installed CAPEX. For example, in the Rectisol® wash unit that can treat 9500 ton/day of a sour syngas, the CAPEX of these compressors can exceed 5% of total CAPEX of this unit.

According to an embodiment of the present invention, as shown in FIG. 5, a set of compressors (22′ and 22) that are used in the common design configuration of Rectisol® process to recycle fuel species to the absorbent column(s) are replaced by single- phase gas-gas ejectors (25 and 25′). The small fraction (2-7 mass %) of the high pressure stream can be used as motive flows of these ejectors (25 and 25′) in order to boost the pressure of fuel species and return them back into the feed stream of the absorber section. This ejector integration strategy can lead to reduction of total CAPEX of this acid gas removal unit by at least 5%. Moreover, the inherent utility cost of mechanical vapour compressors (electricity as high quality source of energy) and their involved GHG emissions will be eliminated.

Typical composition and operating condition of syngas and purified gas are presented in Table 1.

TABLE 1
Typical composition and operating conditions of raw gas
and purified gas in Rectisol ® process

| | Mole % | | | | | Temperature | Pressure |
|---|---|---|---|---|---|---|---|
| Flow stream | CO₂ | H₂S | CO | N₂ | H₂ | (° C.) | (bar) |
| Raw gas (1) | 28.0 | 1.3 | 23.4 | 0.4 | 46.9 | 30 | 35 |
| Purified gas (3) | 0.7 | 16 ppb | 32.7 | 0.6 | 66.1 | −45 | 60 |

### Example 2

A schematic of commonly used design configuration for absorbent regeneration section of Rectisol® gas cleaning unit is shown in FIG. 7.

Loaded absorbents (24′ or 24) are typically loaded by CO₂ and H₂S with 5-20 mole % and about 1 mole %, respectively. The temperature of 24′ or 24 are in the range of −45° C. to −10° C., respectively, while their pressure is in the range of 2 to 20 bar. Since the absorption section is operated at higher pressure, this stream is depressurized using a valve 20 and is fed to absorbent regeneration unit(s) 8 at the middle which is flashed inside the unit(s) and release the impurities in vapour state and the regenerated solvent flows down and washes the lower portion of the unit(s). In this configuration a condenser 27 is used at the top of the unit(s) in which all the absorbent in the vapour state is condensed and return back to the unit(s) to wash the upper portion of the unit(s). In this unit(s), H₂S and residual CO₂ are stripped and can be sent to the other processing unit such as CLAUS process. The reboiler 26 (e.g. kettle reboiler) at the bottom of the unit(s) can further remove the acid gases in the absorbent and send the almost pure lean absorbent 5 (for example methanol) to the absorption unit. Typical composition and operating condition of acid gases 9 and lean absorbent 5 (for example methanol) are presented in Table 2 below.

The reboiler uses a large amount live steam to provide the required heat of desorption. For example in the Rectisol® wash unit that can treat 9500 ton/day of a sour syngas/raw gas, the required live steam represents about 45% of total utility cost of the whole unit.

According to one embodiment of the present invention, as shown in FIG. 9, novel revamp strategy of the Rectsiol® process is introduced by replacing depressurizing valve 20 in FIG. 8 with two-phase liquid-gas ejector(s) 30 that are activated by high pressure loaded liquid absorbent. A part of laden absorbent is taken off at the bottom of absorbent regeneration unit(s) 8 and is flashed to vapourize and recycle back into the absorbent regeneration unit(s) 8 using two-phase ejector(s).

This novel configuration can lead to at least 5% cost saving in live steam consumption and 4000 ton/year reduction in CO₂ emission. Moreover, in this novel design configuration, the flash vapourization is operating at the temperature lower than the reboiler of absorber, it can cool down the regenerated lean absorbent 5 (for example methanol) that can reduce the refrigeration energy requirement by 10 to 20%.

TABLE 2
Typical composition and operating conditions of acid gases
and leanabsorbent in Rectisol ® process

| | Mole % | | | Temperature | Pressure |
|---|---|---|---|---|---|
| Flow stream | CO₂ | H₂S | Methanol | (° C.) | (bar) |
| Acid gases(9) | 79.34 | 19.81 | 0.85 | −19 | 1.2 |
| Lean absorbent | 0 | 100 ppb | 100 | 68-69 | 1.2 |
| 5 (methanol) | | | | | |

### Example 3

A schematic of commonly used design configuration for a gas purification process using chemical absorbent (i.e. amine-based) that is upgraded by integrating an MVR system is shown in FIG. 11.

The flue gas from a power boiler containing typically 5-15% of CO₂ is driven through absorber column(s) 2. As the absorption is an exothermic reaction, it should be cooled down to prevent the heat accumulation in the tower and improve the absorption capacity. Therefore, hot absorbent is collected on the chimney tray and pumped to the intercooler 31 and it is returned back to the absorber column(s) 2. The treated flue gas is released to atmosphere. The CO₂ enriched amine from bottom of absorber is heated in a lean-rich exchanger 32 and sent to the amine regenerator. The amine is regenerated by a heat provided by reboiler 26 and MVR.

As can be seen in FIG. 11, a part of lean amine from the bottom of absorbent regeneration unit(s) 8 is sent to expansion valve 28 and heat exchanger 29 and water vapour is generated and released from separator 21. The compressed water vapour from mechanical vapour compressor 22 is introduced at the bottom of absorbent regeneration unit(s) 8 (for example, amine regenerator) that contributes to the stripping of CO₂ and minimizes the stream requirement.

Overhead of absorbent regeneration unit(s) 8 (for example, amine regenerator) is cooled by a condenser 27 and the reflux is returned back to regenerator whereas the CO₂ is often sent to gas compression system. Although the MVR system can decrease the steam requirement of absorbent regeneration unit(s) 8 (for example, amine regenerator), the mechanical compressor used in this system is expensive and consumed high quilt energy (i.e. electricity). In the amine wash unit that can treat about 1,200 to 1,400 ton/day of a flue gas by removing 90% of its CO₂, the average steam consumption is about 2-3 GJ/ton of CO₂ capture.

According to one embodiment of the present invention, FIG. 12 discloses a novel configuration for integration of ejector technology. This novel configuration can lead to significant reduction in energy consumption of this process.

In this configuration, the waste heat, at temperature of 160 to 170° C., generated in the absorbent column and other upstream and downstream process units, such as tar removal units and catalytic reactors, can be utilized through intercooler heat exchanger 33 to activate a single-phase ejector 25 which is used as a thermo-compressor. Using this novel waste energy management by ejector technology, steam consumption in the reboiler of stripper column can be reduced up to 15%. Moreover, existing electrical or mechanical vapour compressor can be eliminated which is an expensive piece of equipment.

### Example 4

This example relates to the purification of syngas/raw gas using the same system as depicted in FIG. 12.

The so-called syngas/raw gas is composed of H2 (13.10, Mol. %), CO₂ (19.40, Mol. %), CO (8.10, Mol. %), H₂O (50.70, Mol. %), CH₄ (7.80, Mol. %), C₂H₄ (0.10, Mol. %), C₂H₆ (0.20, Mol. %), C₁₀H₈ (0.10, Mol. %), NH3 (0.10, Mol. %), and H₂S (0.04, Mol. %).

The goal is to remove at least 95% of CO₂ and 99.99% of H₂S. The inlet temperature of syngas/raw gas is 169° C. The amine absorber used is composed of 77 stages and average pressure drop of 0.48 bar. The temperature increases from 40.6° C. (corresponding to stage 1) to 68.3° C. The amine regenerator is composed of 23 stages with reboiler and condenser with a pressure drop of 0.70 bar. The integration of an ejector between the flash tank and the amine regenerator led to remove 95% 95% of CO₂ and 99.996% of H₂S with steam savings of about 12% in the reboiler. The ejector 25 is activated by generated steam at 6 bar and boost the pressure of the drawn secondary flow from the separator 21 from 1 to 1.5 bar.

Although the present invention has been described in considerable detail with reference to certain preferred embodiments thereof, other embodiments and modifications are possible. Therefore, the scope of the appended claims should not be limited by the preferred embodiments set forth in the examples, but should be given the broadest interpretation consistent with the description as a whole.

1. Use of an ejector in a gas purification system, wherein high-pressure gas or liquid stream in the gas purification system is used as a motive flow in the ejector, wherein the ejector then compresses the gas stream to be sent back to upstream high-pressure vessels.

2. The use according to claim 1, wherein high-pressure gas stream is used and the ejector is a single-phase gas-gas ejector.

3. The use according to claim 1, wherein high-pressure liquid stream is used and the ejector is a two-phase liquid-gas ejector.

4. The use according to claim 1, wherein the gas purification system is for removing acidic components comprising CO₂, H₂S, SO₂, COS or a combination of at least two of these components.

5. The use according to claim 1, wherein a plurality of the ejectors is used, wherein said ejectors are operationally located in series, in parallel, or a combination thereof.

6. The use according to claim 1, wherein a loaded or partially loaded absorbent is used to compress the gas to produce a gas-liquid mixture with increased pressure.

7. A gas purification system, wherein:
a feed of raw gas comprising acidic gases is treated in an absorber column by a lean absorbent entering into the absorbent column and in contact with said acidic gases,
said lean absorbent absorbs acidic gases to provide a laden absorbent,
said laden absorbent with acid gases is then depressurized by a valve to separate volatile fuel species that are co-absorbed with acid gases in a separator to provide a loaded absorbent,
the loaded absorbent is returned into the absorbent column by being injected into the feed gas using an ejector.

8. The system according to claim 7, wherein the ejector is a single-phase gas-gas ejector.

9. The system according to claim 7, wherein the ejector is a two-phase liquid-gas ejector.

10. The system according to claim 7, wherein the gas purification system is for removing acidic components comprising CO₂, H₂S, SO₂, COS or a combination of at least two of these components.

11. The system according to claim 7, wherein a plurality of the ejectors is used, wherein said ejectors are operationally located in series, in parallel, or a combination thereof.

12. The system according to claim 7, wherein a loaded or partially loaded absorbent is used to compress the gas to produce a gas-liquid mixture with increased pressure.

13. A gas purification system, wherein:
a feed of raw gas comprising acidic gases is treated in an absorber column by a lean absorbent entering into the absorbent column and in contact with said acidic gases, said lean absorbent absorbs acidic gases to provide a laden absorbent,
said laden absorbent with acid gases is then depressurized by a first valve to separate volatile fuel species that are co-absorbed with acid gases in a separator to provide a loaded absorbent,
the loaded absorbent is depressurized using a second valve and fed to absorbent regeneration unit using an ejector.

14. The system according to claim 13, wherein the ejector is a single-phase gas-gas ejector.

15. The system according to claim 13, wherein the ejector is a two-phase liquid-gas ejector.

16. The system according to claim 13, wherein the gas purification system is for removing acidic components comprising CO₂, H₂S, SO₂, COS or a combination of at least two of these components.

17. The system according to claim 13, wherein a plurality of the ejectors is used, wherein said ejectors are operationally located in series, in parallel, or a combination thereof.

18. The system according to claim 13, wherein a loaded or partially loaded absorbent is used to compress the gas to produce a gas-liquid mixture with increased pressure.
